(19) United States
(12) Patent Application Publication
(10) Pub. No.: US 2020/0302386 A1
(43) Pub. Date: Sep. 24, 2020

(54) SYSTEMS AND METHODS FOR DELIVERING A PACKAGE

(71) Applicant: Michael NATANZON, New York, NY (US)

(72) Inventor: Michael NATANZON, New York, NY (US)

(21) Appl. No.: 16/359,639

(22) Filed: Mar. 20, 2019

(51) Int. Cl. G06Q 10/08

(52) U.S. Cl. CPC G06Q 10/0836; G06Q 10/08355

(57) ABSTRACT

The present disclosure provides a package delivery system. The system includes one or more receptacles, each of the one or more receptacles are configured for storing a package and conveyable on a guideway network between a first station and a second station. The guideway network includes a first set of guideways for allowing transportation of the one or more receptacles between the first station and the second station and a second set of guideways for parking the one or more receptacles on either of the first station and the second station. A control unit is communicably coupled with one or more computing devices for receiving a delivery information pertaining to the package. The control unit is configured to operate each receptacle of the one or more receptacles corresponding to the delivery information received from the one or more computing devices for delivering the package.

### TECHNICAL FIELD

The present disclosure relates to systems and methods for delivering a package and, more particularly to, automated systems and methods for delivering the package from one location to another.

### BACKGROUND

A delivery system is a process of conveying packages, such as but not limiting to items, products or goods, to a recipient who may be an individual, group of individuals or an organization, or to a location. Many automatic delivery systems are known in the art, such as automated wheeled delivery robots, traditional parcel delivery services, mail services and so on.

However, all the above-mentioned delivery systems are much slower at delivering packages, as roadways are typically used for commuting to the recipient's location to deliver the package. The transportation on roadways not only affects the delivery times due to slower transportation speed (particularly due to traffic), but also pollutes the environment due to use of fossil-fueled vehicles and may also add undesirable strain on road infrastructure due to the repeated use of heavy trucks for delivery. Further, the weather conditions also complicate the current delivery services, particularly during or after snow storms or floods, weather can prohibit delivery of packages or even emergency supplies.

To mitigate the aforementioned problems associated with conventional delivery systems, drones are employed for delivering the package. The drone being an unmanned aerial vehicle, allows the user to operate the drone remotely, thereby mitigating the problems associated with controlling the wheeled vehicles. Moreover, the drone being airborne is not affected by the traffic that is typically associated with the conventional wheeled vehicle, thereby improving the transportation speeds. However, the drone is characterized with relatively lower top speed, the smaller weight capacity for carrying packages and limited landing or parking area, particularly in a city. Moreover, the drone requires substantially high initial investment and periodic maintenance, which inherently affects the cost of the delivery services offered, making it less convenient for the user.

Therefore, there is a need for techniques which can overcome one or more limitations stated above in addition to providing other technical advantages.

### SUMMARY

Various embodiments of the present disclosure provide a package delivery system. The system includes one or more receptacles, each of the one or more receptacles are configured to store a package and conveyable on a guideway network between a first station and a second station. The guideway network includes a first set of guideways for allowing transportation of the one or more receptacles between the first station and the second station and a second set of guideways for parking the one or more receptacles on either of the first station and the second station. A control unit is communicably coupled with one or more computing devices for receiving a delivery information pertaining to the package. The control unit is configured to operate each receptacle of the one or more receptacles corresponding to the delivery information received from the one or more computing devices for delivering the package.

In an embodiment of the present disclosure, a method for delivering the package via the package delivery system is disclosed. The method includes receiving, by a control unit, the delivery information pertaining to the package from the user via one or more computing devices, wherein the delivery information includes a delivery location and instructions pertaining to the package to be delivered. The control unit then computes an optimal route in the first set of guideways of the guideway network for transporting each receptacle of the one or more receptacles between the first station and the second station. The optimal route is computed based on the delivery information received from the user and location of each of the one or more receptacles traveling on each receptacle of the first set of guideways. Subsequently, the control unit transports each receptacle via the conveying mechanism from the first station to the second station on the optimal route for delivering the package, wherein the first station is a receiving location of the package and the second station is a delivery location of the package.

In an embodiment, the present disclosure also provides the package delivery system. The system including the one or more receptacles, each receptacle of the one or more receptacles configured for storing the package and conveyable on the guideway network between the first station and the second station. The guideway network including the first set of guideways for allowing transportation of each receptacle of the one or more receptacles between the first station and the second station, and the second set of guideways for parking each receptacle of the one or more receptacles on either of the first station and the second station. One or more intermediate guideways are configured on the guideway network for interconnecting each of the first set of guideways and the second set of guideways, as well as interconnecting different guideways within the first set of guideways. A switching mechanism interconnects the first set of guideways and the second set of guideways via the one or more intermediate guideways. The switching mechanism including a flange mounted on each of the first set of guideways and the second set of guideways, and coupled to a switching actuator for operating between a first position and a second position. At the first position the flange is configured to allow transportation of each receptacle of the one or more receptacles along a guideway of the first set of guideways. At the second position the flange is configured to allow switching a lane of each receptacle of the one or more receptacles from the guideway of the first set of guideways to another guideway in the second set of guideways for parking. The receptacle of the one or more receptacles comprising a closure being operable between an open position and a closing position. The closure is configured with a locking mechanism being communicably coupled with the control unit and operable between an unlocked position and a locked position. The locking mechanism is operable to the unlocked position based on an authentication means input by a user. The conveying mechanism being engaged to the guideway of the first set of guideways, the conveying mechanism comprising at least one wheel engaged to the guideway and each wheel of the at least one wheel being coupled to an actuator powered by a power source for enabling transportation of the receptacle between the first station and the second station. A lift mechanism including a first end mounted to the guideway network and another end coupled to the receptacle is provided. The lift mechanism is configured to suspend the receptacle at a predetermined height above the ground surface. A Global Positioning System (GPS) sensor communicably coupled with the control unit is provided for determining location of the receptacle, wherein the control unit determines the speed of the receptacle traveling on the guideway network based on the rate of change in location. Further, a proximity sensor is communicably coupled to the control unit for controlling the movement of the receptacle during transportation. The control unit communicably coupled with one or more computing devices for receiving a delivery information pertaining to the package. The control unit being configured to operate the receptacle corresponding to the delivery information received from the one or more computing devices for delivering the package. The delivery information received by the control unit from the user via the one or more computing devices includes a delivery location and instructions pertaining to the package to be delivered, wherein the control unit being communicably coupled with the closure, the locking mechanism, the conveying mechanism, the lift mechanism, the GPS sensor and the proximity sensor for controlling operation of the receptacle.

### BRIEF DESCRIPTION OF THE FIGURES

The following detailed description of illustrative embodiments is better understood when read in conjunction with the appended drawings. For the purpose of illustrating the present disclosure, exemplary constructions of the disclosure are shown in the drawings. However, the present disclosure is not limited to a specific device or a tool and instrumentalities disclosed herein. Moreover, those in the art will understand that the drawings are not to scale. Wherever possible, like elements have been indicated by identical numbers:

FIG. 1 is a block diagram representing an environment of a package delivery system related to some example embodiments of the present disclosure;

FIG. 2A illustrates a receptacle of the package delivery system of FIG. 1 with a closure in a locked position, in accordance with an example embodiment of the present disclosure;

FIG. 2B illustrates the receptacle of FIG. 2A with the closure in a unlocked position, in accordance with an example embodiment of the present disclosure;

FIG. 3A illustrates a switching mechanism of the package delivery system of FIG. 1 in a first position, in accordance with an example embodiment of the present disclosure;

FIG. 3B illustrates the switching mechanism of FIG. 3A depicting movement of the receptacle in a first set of guideways, in accordance with an example embodiment of the present disclosure;

FIG. 3C illustrates the switching mechanism of FIG. 3A in a second position, in accordance with an example embodiment of the present disclosure;

FIG. 3D illustrates the switching mechanism of FIG. 3C, depicting switching of lanes of the receptacle from the first set of guideways to a second set of guideways, in accordance with an example embodiment of the present disclosure;

FIG. 4A illustrates a lift mechanism of the package delivery system of FIG. 1 connected to the receptacle in a retracted position, in accordance with an example embodiment of the present disclosure;

FIG. 4B illustrates the lift mechanism of FIG. 4A connected to the receptacle in an extended position, in accordance with an example embodiment of the present disclosure;

FIG. 4C illustrates the lift mechanism of FIG. 4A, in accordance with another embodiment of the present disclosure;

FIG. 4D illustrates the lift mechanism of FIG. 4B, in accordance with another embodiment of the present disclosure;

FIG. 5 is a block diagram of a method of delivering a package via the package delivery system, in accordance with an embodiment of the present disclosure; and

FIG. 6 is a block diagram of a server, in accordance with an example embodiment of the present disclosure.

The drawings referred to in this description are not to be understood as being drawn to scale except if specifically noted, and such drawings are only exemplary in nature.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

Reference in this specification to “one embodiment” or “an embodiment” means that a particular feature, structure, or characteristic described in connection with the embodiment is included in at least one embodiment of the present disclosure. The appearance of the phrase “in an embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

### Overview

Various embodiments of the present disclosure provide a package delivery system. The system is configured to deliver packages to the desired or required location, in a time efficient manner, while also eliminating the dependency on roadways for delivering the packages. The system also mitigates the need for fuel enabled transportation for delivering the packages, thereby is eco-friendly.

The system includes one or more receptacles configured for storing a package required to be delivered to a desired location. The receptacles are conveyable on a guideway network which connects a first station and a second station. The first station may be a receiving location of the package and the second station may be the delivery location of the package. The guideway network includes a first set of guideways for transportation of the receptacles between the first station and the second station, and a second set of guideways for parking the receptacles in either of the first station and the second station. One or more intermediate guideways are provided in the guideway network for interlinking or interconnecting the first set of guideways with the second set of guideways. This provision ensures that the receptacles can move between the first set of guideways and the second set of guideways as per requirement. A conveying mechanism, which may include at least one wheel is mounted on one of the guideways of the guideway network, and is configured on each of the receptacles for transportation of the package between the first station to the second station. The conveying mechanism also enables switching of lanes of the receptacles from the first set of guideways to the second set of guideways via a switching mechanism upon reaching the delivery location, for parking the receptacles. The switching network includes a flange coupled to an actuator and mounted on each of the first set of guideways and the second set of guideways. The flange is operable between a first position and a second position, wherein at the first position the flange allows transportation of each of the receptacles along the first set of guideways. The flange at the second position is configured to interconnect each of the intermediate guideways with the first set of guideways suitably, for allowing transportation of the receptacles to the second set of guideways from the first set of guideways. A control unit is provided in the system and is communicably coupled with one or more computing devices, the receptacles, the conveying mechanism and the switching mechanism. The control unit is configured to receive a delivery information, from the one or more computing devices of the user, such as the delivery location and other instructions pertaining to the package. The control unit based on the delivery information controls the operations of the receptacles for delivering the package.

The present disclosure also provides a method for delivering the package via the package delivery system. The method comprising receiving by the control unit, the delivery information pertaining to the product from the user via the computing devices. The control unit, based on the delivery information and the delivery location selected by the user, computes an optimal route for transportation of the receptacle on the first set of guideways from the first station to the second station. The control unit, upon reaching the second station via the optimal route, operates the switching mechanism to the second position for interconnecting the first set of guideways to the second set of guideways. The interconnection enables transportation of the receptacles to the second set of guideways, so that the receptacles are parked at the second station. The user thereupon may access the package stored with the receptacles by unlocking the locking mechanism using suitable authentication means.

Although process steps, method steps or the like in the disclosure may be described in a sequential order, such processes and methods may be configured to work in alternate orders. In other words, any sequence or order of steps that may be described in this patent application does not, in and of itself, indicate a requirement that the steps be performed in that order. The steps of described processes may be performed in any practical order. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the invention(s), and does not imply that the illustrated process is preferred.

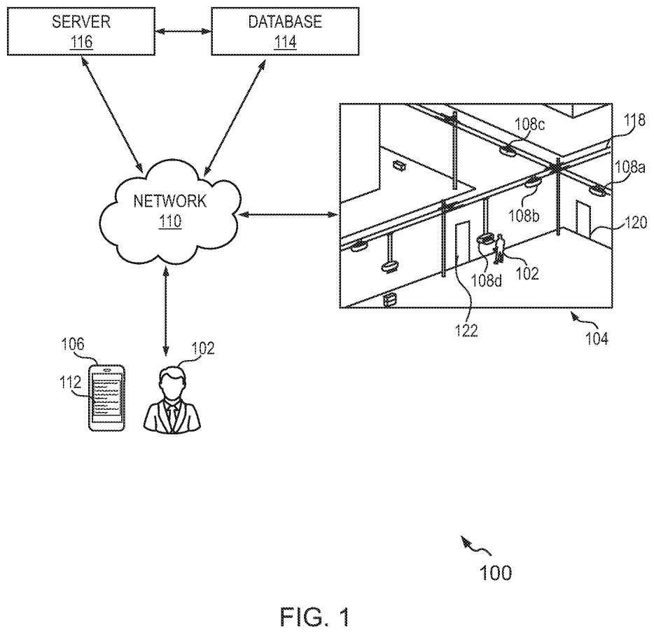

Various embodiments with respect to systems and methods for delivering packages in FIG. 1 to FIG. 6.

FIG. 1 shows an example representation of an environment 100 related to at least some embodiments of the present disclosure. The environment 100 includes a user 102, such as an individual or a business, who wishes to order a package or to deliver the package to another user at a desired location. The user 102 interacts with a package delivery system 104 (hereinafter referred to as system 104), for placing a delivery request of a package at the desired location. The user 102 while placing the delivery request provides information pertaining to a delivery location and instructions pertaining to the package. The user 102 can interact with the system 104, via a network 110 using an application 112 available at one or more computing devices 106 (hereinafter referred to as ‘device 106’) associated with the user 102. The application 112 may be a web-based application or a mobile based application accessible via the device 106 associated with the user 102. The device 106 may be one of laptops, smartphones, desktops, tablets, personal digital assistants (PDAs), wearable smart devices, workstation terminals and the like. The network 110 may be a centralized network or a decentralized network or may include a plurality of sub-networks that may establish a direct communication between the entities or may offer indirect communication between the entities. Typical examples of the network 110 include, but are not limited to, a wireless or wired Ethernet-based network, a local or wide-area network (LAN or WAN), and/or the global communication network known as the Internet, which may accommodate many different communications media and protocols.

The environment 100 further includes a server 116 configured to control operations of the system 104 for delivering the package to the desired location, based on the delivery request made by the user 102. The server 116 may particularly control operations of one or more receptacles 108a, 108b, 108c, 108d (hereinafter singularly referred to as ‘receptacle 108’ for the receptacles 108a, 108b, 108c, 108d) of the system 104, which is explained in detail in subsequent description. The server 116 may be configured to manage the application 112, which is accessible to the device 106, so that the delivery request provided by the user 102 is received by the server 116. The application 112 may be accessible through a website associated with the server 116, so that the user 102 may access the website over the network 110 using Web browser applications installed in the device 106 for providing the delivery request. The server 116 upon receiving the delivery request is configured to control the operations of the system 104 for delivering the package to the desired location of the user 102. In an embodiment, the server 116 is configured to facilitate instances of the application 112 to the device 106 upon receiving a request for accessing the application 112. The server 116, upon receiving the request, may allow instances of the application 112 to be downloaded into the device 106, for the user 102 to access the application 112. In an embodiment, the application 112 may include an Application programming Interface (API) and other components, which may rest on the server 116. The application 112 can be made available at application stores such as Google play store managed by Google®, Apple app store managed by Apple®, etc. and are downloadable from the application stores to be accessed on devices such as the device 106 of the user 102. In an embodiment, the application 112 may be pre-installed on the device 106. In an embodiment, the server 116 may be a standalone device or a device associated with the system 104 or may be maintained by a third-party, for controlling operation of the system 104 for delivering the package.

The environment 100 further includes a database 114 associated with the user 102 and configured to store information pertaining to the delivery request provided by the user 102. The delivery request provided by the user 102 may be the delivery location and the instructions pertaining to the package. The delivery location provided by the user 102 while providing the delivery request, may be one of a residential location, a business location or any other location as per feasibility and requirement. The instructions provided by the user 102 while providing the delivery request, may be guidelines or recommendations for safe and timely delivery of the package. The instructions may also be one of a time-definite delivery request, type of packing provided for safety of the package, a prior intimation to the user 102 before delivering the package, an intimation to the user 102 upon delivery of the package, a prior intimation to a receiver before arrival of the package and the like. The database 114 may also store details pertaining to the system 104 required for the server 116, for delivering the package to the desired location.

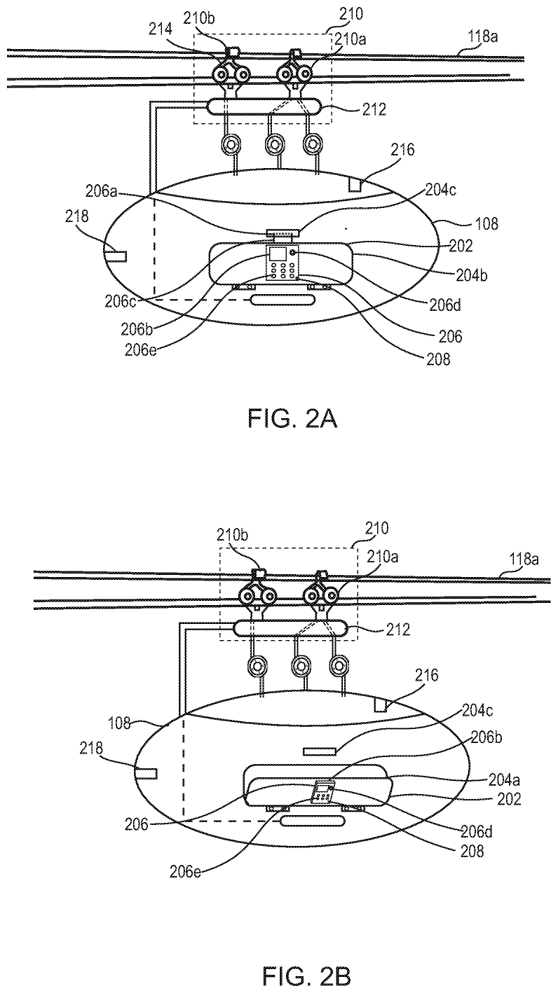

The server 116 upon receiving the delivery information from the user 102 is configured to control operations of the system 104, so that a receptacle 108 which is nearest to the first station 120 is identified by the system 104, then the receptacle 108 takes an optimal route for reaching the first station 120 via a guideway network 118, then delivering the package from a first station 120 to a second station 122 via a guideway network 118. The guideway network 118 includes a first set of guideways 118a and a second set of guideways 118b, which is explained in subsequent sections. The server 116 may also be configured to collect real time data pertaining to the receptacle 108 such as but not limiting to a current location of the receptacle 108, a speed of operation of the receptacle 108 and the like, via one or more sensors embedded within the receptacle 108, which are explained in detail in FIGS. 2A to 2D. The server 116 thus acts as a control unit or a processor, for controlling operation of the receptacle 108 and the system 104, to ensure delivery of the package.

FIGS. 2A and 2B, in an exemplary embodiment of the present disclosure, illustrates a planar view of the receptacle 108. The receptacle 108 is a hollow structure, configured with a closure 202, for enclosing the contents therein. The closure 202 is operable between an open position 204a (for e.g. as shown in FIG. 2B) and a closed position 204b. The closure 202 may be hinged to the receptacle 108 for actuation between the open position 204a and the closed position 204b. Alternatively, the closure 202 may be snap fitted or attached by other conventional mechanical techniques as per feasibility and requirement. The closure 202 may also be positioned at the underside of the receptacle 108, and allow the receptacle 108 to pick up and drop off packages without direct interaction with a user 102 at the time of pick up or delivery. The closure 202 includes a locking mechanism 206 communicably coupled to the server 116 (i.e. the control unit). The locking mechanism 206 is operable between a locked position 206a and an unlocked position 206b, for operating the closure 202 between the open position 204a and the closed position 204b. The locking mechanism 206 may include a lever 206c which in the locked position 206a may engage with a keyhole member 204c configured on the surface of the receptacle 108 for locking the closure 202 in the closed position 204b. The locking mechanism 206 in the unlocked position 206b, the lever 206c disengages with the keyhole member 204c of the receptacle 108, thereby allowing actuation of the closure 202 from the closed position 204b to the open position 204a. The locking mechanism 206 is adapted to be operable to the unlocked position 206b from the locked position 206a upon receiving an authentication means from the user 102. The authentication means may be a secret information shared with the user 102 by the server 116, upon initiating the delivery request by the user 102 and can be any one of a Quick Response (QR) code, an One Time Password (OTP), an iris recognition data, a face recognition data, a voice recognition data and the like. Accordingly, the locking mechanism 206 may include a camera 206d for determining the facial features and the iris features of the user 102. Also, a microphone 208 may be embedded in the locking mechanism 206 for determining the voice of the user 102 for unlocking the closure 202. Alternatively, other security authentication means such as a Radio Frequency Identification (RFID) card, a fingerprint, a key card or any other security authentication means may be employed for operating the locking mechanism 206. Accordingly, the hardware of the locking mechanism 206 may be altered for enabling use of various security authentication means. Further, the locking mechanism 206 may include a keypad 206e for keying in the security information such as but not limited to the One-Time Password received by the user 102 upon initiating the delivery request of the package. Thus, the locking mechanism 206 is configured with myriad of safety features, to ensure that the package is accessible to the user 102. Similarly, the authentication means may use security mechanism (not shown in Figures) embedded in the smart device 106 used by user 102. Such authentication means may be used when user 102 is within a certain predetermined distance from the receptacle 108 and in conjunction with identifying information located on the server 116.

The receptacle 108 is conveyable on the guideway network 118 (for e.g. as shown in FIG. 1) between the first station 120 and the second station 122. The first station 120 may be a location where the package is received by the receptacle 108, such as but not limiting to a warehouse, a recipient location, a location of the user 102 and the like. The second station 122 may be the location where the package is delivered by the receptacle 108, such as the delivery location specified by the user 102. The guideway network 118 includes a plurality of guideways, which may be made of cables wires, for connecting the first station 120 and the second station 122. Additionally, the guideway network 118 may include rails for connecting the first station 120 and the second station 122. In an embodiment, the guideway network 118 may be configured to connect the first station 120 and the second station 122 in a city premise or within an industry or any other premises as per feasibility and requirement.

The guideway network 118 includes the first set of guideways 118a, for transportation of the receptacle 108 between the first station 120 and the second station 120. The first set of guideways 118a includes a plurality of guideways which act as a transport lane for movement of the receptacle 108. Each of the guideways in the first set of guideways 118a may interconnect various stations or locations apart from connecting the first station 120 and the second station 122, as per the premises selected. In other words, the first set of guideways 118a may also connect locations between or beyond the first station 120 and the second station 122, so as to improve connectivity within the premises considered. The guideway network 118 also includes the second set of guideways 118b for parking the receptacle 108 on either of the first station 120 and the second station 122. The second set of guideways 118b may extend corresponding to the connectivity of the first set of guideways 118a and thus may be dependent on the network of the first set of guideways 118a. In other words, the second set of guideways 118b extends in locations where the first set of guideways 118a extends, so as to ensure parking of the receptacle 108.

A conveying mechanism 210 is configured on the receptacle 108 for conveying or transportation of the receptacle 108 between the first station 120 and the second station 122. The conveying mechanism 210 is configured to be mounted on one of the guideways in the first set of guideways 118a to enable transportation of the receptacle 108 between the first station 120 and the second station 122. Alternatively, the conveying mechanism 210 may also be mounted on one of the guideways in the second set of guideways 118b.

The conveying mechanism 210 includes at least one wheel 210a mounted on one of the guideways of the first set of guideways 118a. The wheel 210a may be mounted onto one of the guideways of the first set of guideways 118a via a hook member 210b. Each of the at least one wheel 210a is coupled to an actuator 212 such as but not limiting to an electric motor, a hydraulic actuator, a pneumatic actuator and the like, via a bracket 214 for allowing movement over the first set of guideways 118a. A transmission mechanism (not shown in FIGs.) may be coupled to the wheel 210a, for transmitting power from the actuator 212 to the wheel 210a. The actuator 212 upon actuation is configured to operate the wheel 210a either in a clockwise direction or in an anti-clockwise direction, which in-turn will move the receptacle 108 in a forward direction or in a reverse direction. The actuator 212 may be coupled to the server 116, so that the server 116 may control movement of the receptacle 108 as per requirement.

In an embodiment, the conveying mechanism 210 consists of a motor-guided haul rope (not shown in Figures) which pulls the receptacle 108 along the guideway. In such configuration, the receptacle 108 includes a mechanism (not shown in Figures) to attach to and detach from a haul rope, as well as switch between haul ropes as required to move within the guideway network 118.

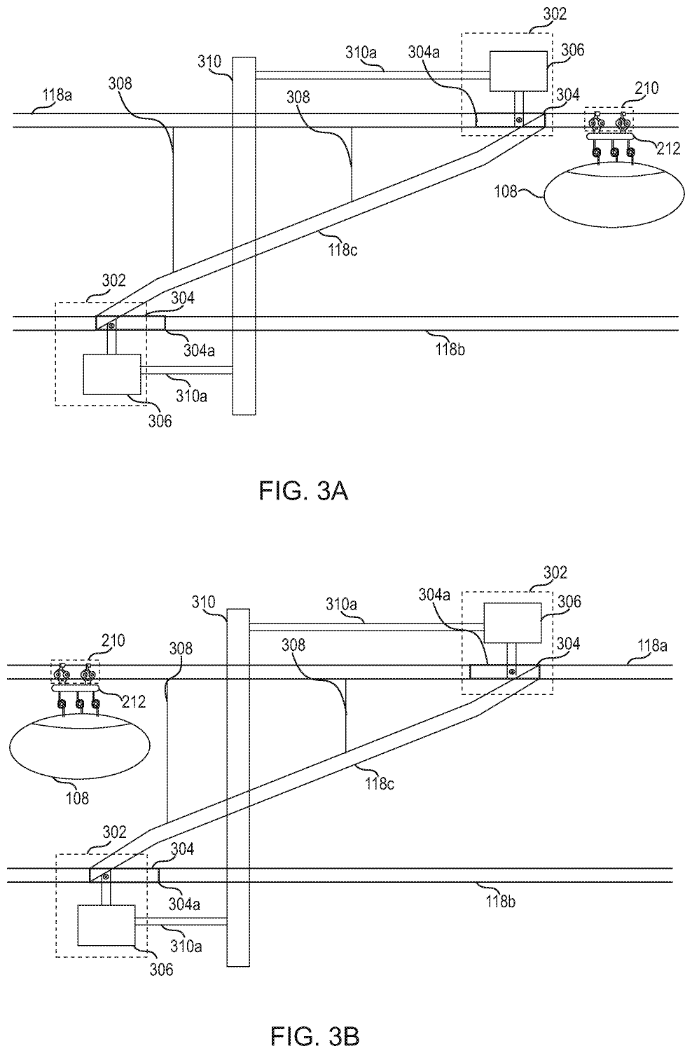

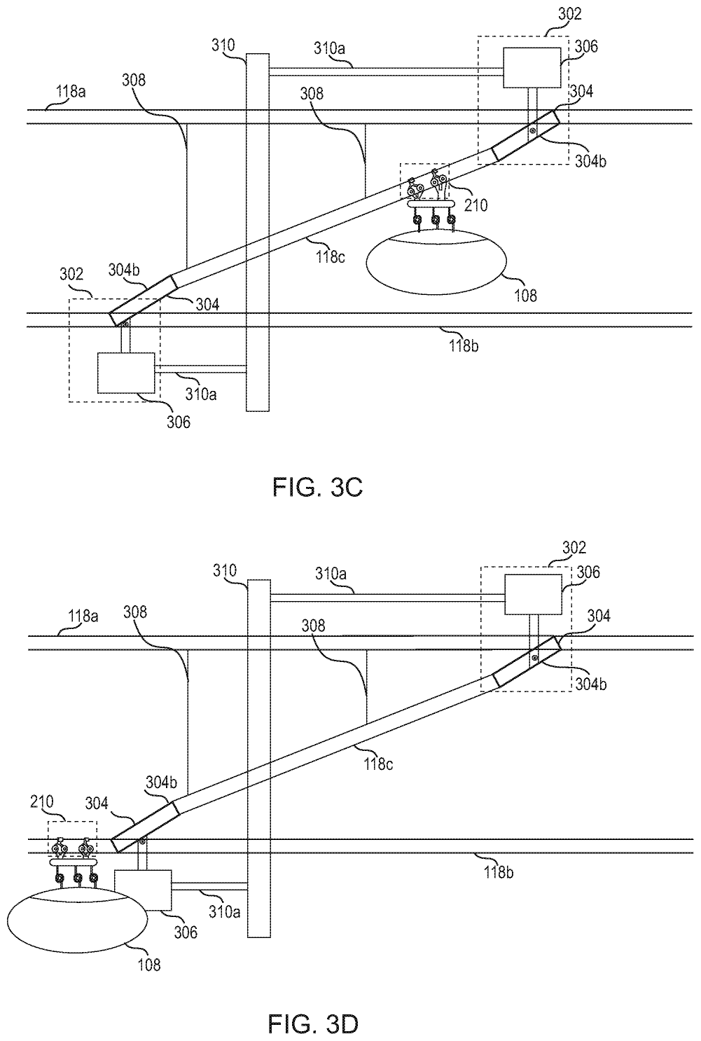

Further, the guideway network 118 also includes one or more intermediate guideways 118c (for e.g. as shown in FIGS. 3A-3D), which are configured to interconnect the first set of guideways 118a and the second set of guideways 118b. The intermediate guideways 118c bridges the first set of guideways 118a with the second set of guideways 118b, so that the receptacle 108 can move between the first set of guideways 118a and the second set of guideways 118b. The intermediate guideways 118c may be supported by the first set of guideways 118a and the second set of guideways 118b via support members 308, for maintaining an intermediate position therebetween (for e.g. as shown in FIGS. 3A to 3D). This configuration of the intermediate guideways 118b enables switching of lanes for the receptacle 108 from the first set of guideways 118a to the second set of guideways 118b, and vice-versa at a desired location. Thus, the intermediate guideways 118c are provided particularly in the first station 120 and the second station 122, so that the receptacles 108 can park either at the first station 120 and the second station 122 for enabling the user 102 to collect the package. Alternatively, the intermediate guideways 118c may be provided between or beyond the first station 120 and the second station 122, based on the connectivity of the first set of guideways 118a with the second set of guideways 118b to ensure that parking of the receptacle 108 at these locations.

Referring to FIGS. 3A to 3D, a switching mechanism 302 is configured in the guideway network 118 and mounted at the connecting junction of the intermediate guideways 118c with the first set of guideways 118a and the second set of guideways 118b. The switching mechanism 302 is configured to switch lanes or guideways of the receptacle 108 between the first set of guideways 118a and the second set of guideways 118b. The switching mechanism 302 includes a flange 304 mounted on each of the first set of guideways 118a and the second set of guideways 118b. The flange 304 is coupled to a switching actuator 306 which is electronically coupled to the server 116, for operating the flange 304 between a first position 304a and a second position 304b. The switching actuator 306 may be supported on a pillar 310 via mounting brackets 310a. The pillar 310 may generally extend from a ground surface at either of the first station 120 or the second station 122 or any other intermediate connecting terminals of the first set of guideways 118a and the second set of guideways 118b. The server 116 is configured to operate the flange 304 via the switching actuator 306 based on the position of the receptacle 108 and the delivery location selected by the user 102.

In the first position 304a, the flange 304 disconnects the intermediate guideways 118c with the first set of guideways 118a and the second set of guideways 118b and thus enable the receptacle 108 to maintain its lane i.e. either on the first set of guideways 118a (for e.g. as shown in FIGS. 3A and 3B) or the second set of guideways 118b. In other words, in the first position 304a, the flange prevents switching of lane of the receptacle 108 between the first set of guideways 118a and the second set of guideways 118b. Thus, if the receptacle 108 is on one of the guideways on the first set of guideways 118a when the flange 304 is in the first position 304a, the receptacle 108 maintains its movement. Similarly, if the receptacle 108 is on one of the guideways on the second set of guideways when the flange 304 is in the first position 304a, the receptacle 108 maintains the parking position.

In the second position 304b, the flange 304 connects the intermediate guideways 118c with the first set of guideways 118a and the second set of guideways 118b and thus enables switching of the lanes of the receptacle 108 from the first set of guideways 118a towards the second set of guideways 118b. Thus, in this juncture, the receptacle 108 move to the intermediate guideways 118c (for e.g. as shown in FIG. 3C) from the first set of guideways 118a. Simultaneously, the flange 304 provided on the second set of guideways 118b are also operated to the second position 304b, to enable the receptacle 108 to move to the second set of guideways 118b (for e.g. as shown in FIG. 3D), where the receptacle 108 is parked, to enable the user 102 for collecting the package. In an embodiment, the flange 304 may be operated pivotally between the first position 304a and the second position 304b by the switching actuator 306. Alternatively, the flange 304 may be oscillated or reciprocated or can be subjected to other movements for operating the flange 304 between the first position 304a and the second position 304b as per requirement.

In an embodiment, the flange 304 may be configured to be a rail switch construction and may be configured with a shape matching the shape of the first set of guideways 118a and the second set of guideways 118b. In an embodiment, the shape of the flange 304 may be selected from one of a rectangular shape, a square shape, a circular shape or any other shape as per design feasibility and requirement.

In an embodiment, the switching actuator 306 may be an actuator selected to be one of a motor, a hydraulic actuator, a pneumatic actuator or any other actuator as per design feasibility and requirement.

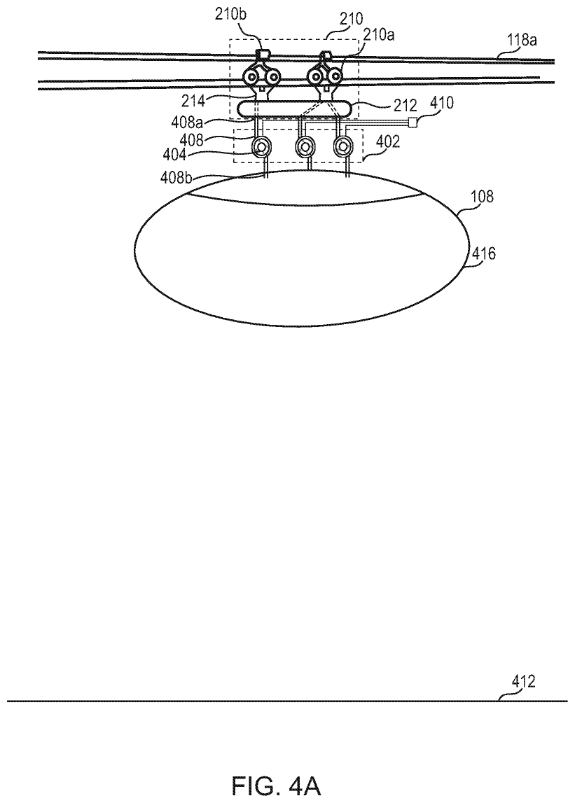

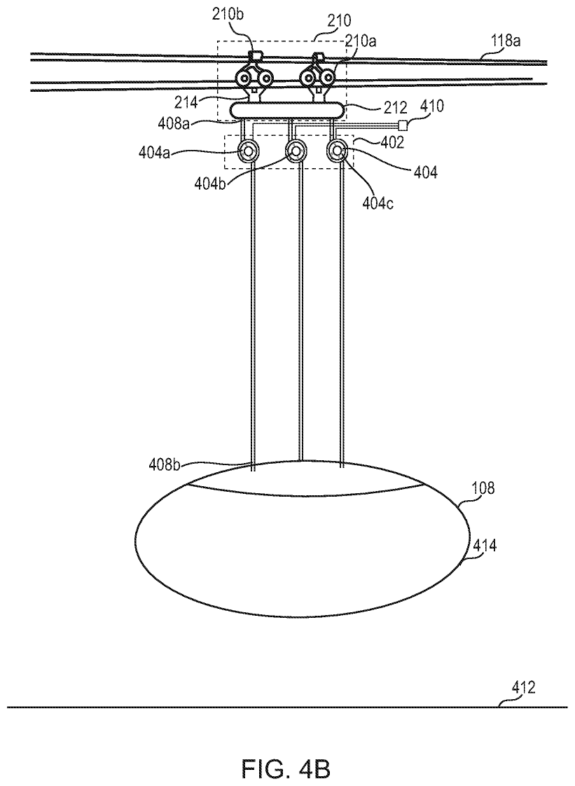

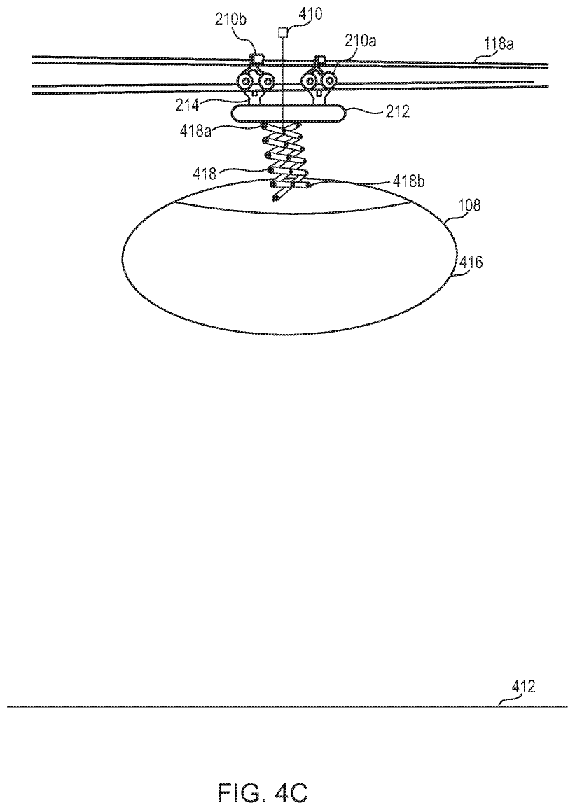

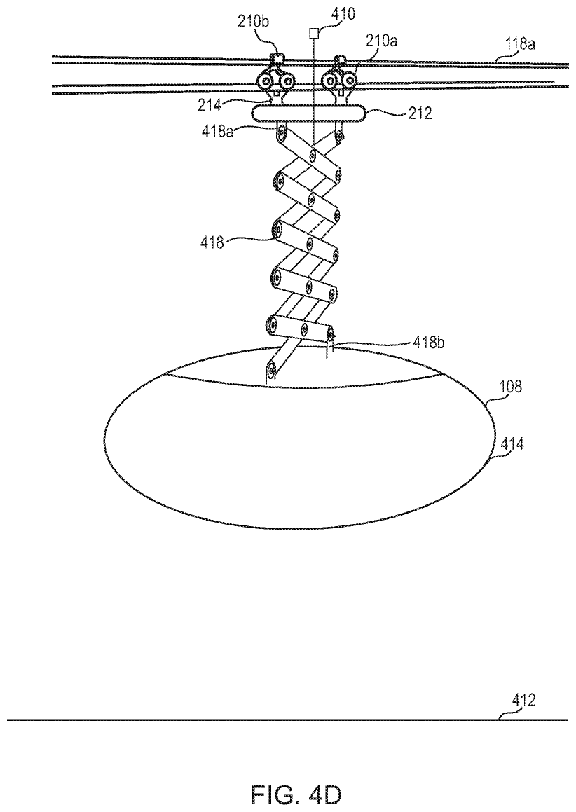

Referring now to FIGS. 4A to 4D, a lift mechanism 402 is configured on the receptacle 108, for lifting and maintaining a predetermined height of the receptacle 108 above a ground surface 412. The lift mechanism 402 prevents use of the road ways as used in the conventional delivery systems, thereby ensuring quicker transportation of the receptacle 108 between the first station 120 and the second station 122. The lift mechanism 402 may be configured to be a cable-pulley mechanism (for e.g. as shown in FIGS. 4A and 4B). The cable pulley mechanism type of the lift mechanism 402 includes a plurality of pulleys 404 (hereinafter referred to as ‘pulleys 404’ and exemplarily represented for pulleys 404a, 404b, 404c) suspended from the bracket 214 connected to the wheel 210a via a cable 408. The cable 408 thus has one end 408a connected to the bracket 214 and other end 408b connected to the receptacle 108, while winding about pulleys 404. Each of the pulleys 404 are coupled to a motor 410, so that the motor 410 can wind and unwind the cable 408 by rotating the pulleys 404. This configuration of the pulleys 404 enables adjustment of the predetermined height above the ground surface 412. Also, this configuration of the pulleys 404 enables operation between an extended position 414 (for e.g. as shown in FIG. 4B) and a retracted position 416 (for e.g. as shown in FIG. 4A). In the extended position 414, the receptacle 108 is proximal to the ground surface 412, which can enable the user 102 to access the closure 202 for collecting the package or storing the package within the receptacle 108. In the retracted position 416, the receptacle 108 is away from the ground surface 412 for ease of transportation of the receptacle 108. Further, the pulleys 404 connect at multiple locations on the receptacle 108, for maintaining lateral stability of the receptacle 108 during movement. In an embodiment, the three pulleys 404a, 404b and 404c are connected at three different points on the receptacle 108, for lateral stability of the receptacle 108 during movement. In an embodiment, the predetermined height to be maintained by the lift mechanism 402 may be the height at which the receptacle 108 may be subjected to minimal obstruction during transportation. In an embodiment, the predetermined height to be maintained by the lift mechanism 402 during parking of the receptacle 108 may be the height at which the receptacle 108 may enable the user 102 to access the package (for e.g. as shown in FIG. 1).

In an embodiment, the lift mechanism 402 may be a scissor mechanism (for e.g. as shown in FIGS. 4C and 4D). In the scissor mechanism, a plurality of links 418 are arranged in a criss-cross pattern, with one end 418a connected to the bracket 214 and the other end 418b connected to the receptacle 108, similar to the configuration of the cable-pulley mechanism described in FIGS. 4A and 4B. The end 418a is connected to the motor 410, so that the extension and retraction of the links 418 are controlled based on operation of the motor 410, thereby controlling the extended position 414 (for e.g. as shown in FIG. 4D) and the retracted position 416 (for e.g. as shown in FIG. 4C) of the receptacle 108. In an embodiment, the end 418b of the links 418 may be coupled to the motor 410 via suitable mechanical means which enables extension and retraction of the links 418 upon actuation of the motor 410. The motor 410 may be coupled to the server 116, which may be configured to control the extended position 414 and the retracted position 416 of the receptacle 108, based on the location of the receptacle 108. In other words, upon detection of movement of the receptacle 108, the server 116 may operate the motor 410 to wind the cable 408 or the links 418 for operating the receptacle 108 to the retracted position 416. Similarly, upon detection of parking of the receptacle 108, the server 116 may operate the motor 410 to unwind the cable 408 or the links 418 for operating the receptacle 108 to the extended position 414.

Referring back to FIG. 2A, the receptacle 108 includes the one or more sensors interfaced with the server 116, for providing real time data pertaining to the operations of the receptacle 108. The one or more sensors may be one of a Global Positioning System (GPS) sensor 216 and a proximity sensor 218, which are placed strategically on or within the receptacle 108. The GPS sensor 216 is configured to determine location of the receptacle 108, while the proximity sensor 218 is configured to determine an obstruction to the receptacle 108 during its transportation. The obstruction may in the form of another receptacle, such as the receptacle 108a, obstructing the path of the receptacle 108. This feature enables the server 116 to compute an optimal route or a fastest route that the receptacle 108 can take in the guideway network 118 for delivering the package. The server 116 is configured to determine the optimal route by considering at least one of parameters such as but not limiting to the number of receptacles 108 currently in operation, their corresponding delivery locations, their current locations and the number of turns the receptacle 108 needs to take for arriving at the required delivery location. The server 116 upon computation of the optimal route operates the receptacle 108 accordingly, thereby ensuring fast delivery of the package. The proximity sensor 218 is also configured to determine the predetermined height the receptacle 108 needs to maintain.

In an embodiment, the server 116 may be a control unit or a processor configured to execute operations of the server 116, for enabling the system 104 to deliver the package.

In an embodiment, the server 116 also monitors the condition of the receptacle 108 during its operation. In other words, the server 116 monitors the condition of each component in the receptacle 108, to determine the service life of the receptacle 108. Upon nearing the service life, the server 116 guides the receptacle 108 to a service station for fixing the receptacle 108.

In an embodiment, the receptacle 108 may include I/O devices, configured for receiving and transmitting signals to the server 116 via the network 110.

In an embodiment, the first set of guideways 118a may include a plurality of guideways for allowing transportation of the receptacle 108 and the second set of guideways 118b may also include another plurality of guideways for allowing parking of the receptacle 108.

In an embodiment, the wheel 210a may engage with multiple guideways of the first set of guideways 118a for additional stability of the receptacle 108 during transportation.

In an embodiment, the receptacle 108 is configured with dimensions 50″×18″×18″ in size and can carry packages that are 30″×12″×12″ and weighs up to 50 lbs.

In an embodiment, the receptacle 108 may be configured to include a guiding mechanism (not shown in Figures) to automatically load and/or unload packages through a vertical opening. The receptacle 108 may include a sensor (not shown in Figures) to scan information on the package as a method of authentication.

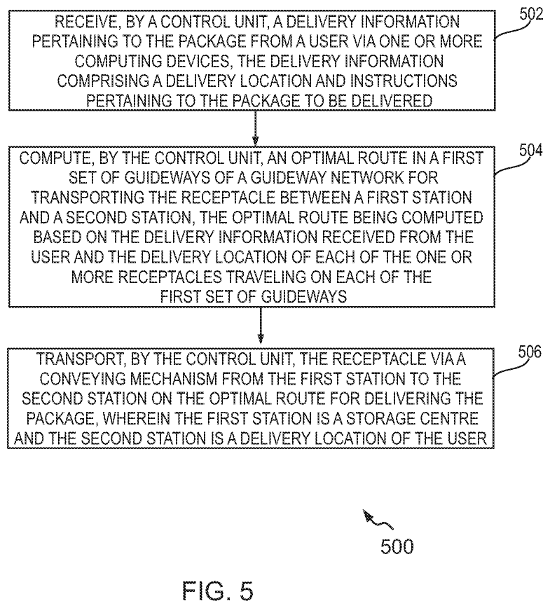

FIG. 5 in one exemplary embodiment of the present disclosure is a flow diagram of a method 500 of delivering a package via the package delivery system 104. The method 500 depicted in the flow diagram may be executed by, for example, the server 116 or the system 104. Operations of the method 500 and combinations of operation in the flow diagram, may be implemented by, for example, hardware, firmware, a processor, circuitry and/or a different device associated with the execution of software that includes one or more computer program instructions.

At operation 502, the method includes, receiving, by the control unit or the server 116 or the processor, the delivery information pertaining to the package from the user 102 via the device 106. The delivery information provided by the user 102 may be the delivery location and instructions pertaining to the package (as already described in FIG. 2A). The delivery information provided by the user 102 is stored within the database 114, so that the control unit can access the information as and when required. Upon receiving the delivery information, the server 116 may determine the receptacle 108, which is available for complying with the delivery request from the user 102. Accordingly, one of the receptacles 108, say receptacle 108a is assigned for delivering the package. In an embodiment, if the delivery request is a new product ordered by the user 102, the server 116 guides the receptacle 108a to travel to a warehouse (not shown in the Figures), for collecting the package to be delivered. In another embodiment, if the delivery request is just to drop of the package available with the user 102, the server 116 guides the receptacle 108a to travel to the location specified by the user 102 or to a location proximal to the location specified by the user 102. Further, the server 116 upon receiving the delivery request transmits a first notification to the user 102. The first notification includes details pertaining to the authentication means that is required to be provided to the locking mechanism 206 for unlocking the closure 206. The first notification may also include details pertaining to the package, the details of the first station, the details of the second station, expected time of delivery of the package and the like.

At operation 504, the control unit or the server 116 computes the optimal route for the transportation of the receptacle 108 from the first station 120 to the second station 122. The server 116 computes the optimal route based on the delivery information and the instructions pertaining to the package provided by the user 102. The server 116 apart from the delivery information and the instructions also considers the first station 120 of the receptacle 108, wherein the first station 120 may be the pick-up location of the package into the receptacle 108. Additionally, the server 116 based on the location from which the delivery request is received, also considers the receptacle 108, say the receptacle 108a nearest to that location for computing the optimal route. Upon computing the optimal route and also selecting the receptacle 108, say the receptacle 108a for delivering the package, the server 116 may operate the closure 202 to the open position 204a for receiving and storing the package within the receptacle 108a. Alternatively, the package may be manually stored within the receptacle 108a by manually opening the closure 202 to the open position 204a by the user 102. Thereafter, the closure 202 is operated to the closed position 204b either manually by the user 102 or automatically by the server 116 for storing the package within the receptacle 108a. Also, the server 116 may also control the lift mechanism 402 suitably for allowing loading of the package into the receptacle 108a. That is, the lift mechanism 402 is operated to the extended position 414 (for e.g. as shown in FIGS. 4B and 4D), while loading the package. Upon loading and locking the closure 202, the server 116 operates the lift mechanism 402 to the retracted position 416 (for e.g. as shown in FIGS. 4A and 4C).

At operation 506, the control unit or the server 116 guides the receptacle 108a via the computed optimal route for transportation from the first station 120 to the second station 122. In this juncture, the server 116 operates the actuator 212 for actuating the wheel 210a for movement of the receptacle 108a. Prior to actuation of the actuator 212, the server 116 operates the flange 304 of the switching mechanism 302 to the second position 304b (for e.g. as shown in FIGS. 3C and 3D), so that the receptacle 108a switches the lane from the second set of guideways 118b to the optimal route or the optimal guideway in the first set of guideways 118a computed by the server 116, via the intermediate guideway 118c. The server 116 while transporting the receptacle 108a monitors the speed, inclination and other parameters of the receptacle 108a, to ensure safe delivery of the package. In an embodiment, the server 116 computes speed of the receptacle 108 based on the rate of change in the location determined by the GPS sensor 216. Upon reaching the second station 122, the server 116 again operates the flange 304 to the second position 304b, so that the receptacle 108a switches the lane from the first set of guideways 118a to the second set of guideways 118b via the intermediate guideway 118c. Upon completely switching into the second set of guideways 118b, the server 116 deactivates the actuator 212, thereby parking the receptacle 108a in the second station 122. In an embodiment, prior to switching of lanes near the second station 122, the server 122 may transmit a second notification to the user 102 (not shown in the Figures) regarding the delivery of the package. The second notification may include details pertaining to the time of delivery of the package, the details of the second station 122, the details of the first station 120 and the like. Once the receptacle 108a is in the parked in the second station 122, the server 116 operates the lift mechanism 402 of the receptacle 108a to the extended position 414 so that the closure 202 is accessible to the user 102. In this juncture, the user 102 inputs the authentication means into the input device of the locking mechanism 206, or into his smart device 106, for unlocking the closure 202. The user 102 then collects the package within the receptacle 108a.

In an embodiment, the server 116 may store all the data pertaining to the transportation occurred with the receptacle 108a in the database 114 for use as and when required.

In an embodiment, the first notification and the second notification transmitted by the server 116 may be in form of a text message, a voice call, a pop-up displayed onto the device 106 of the user 102 or any other means as per feasibility and requirement.

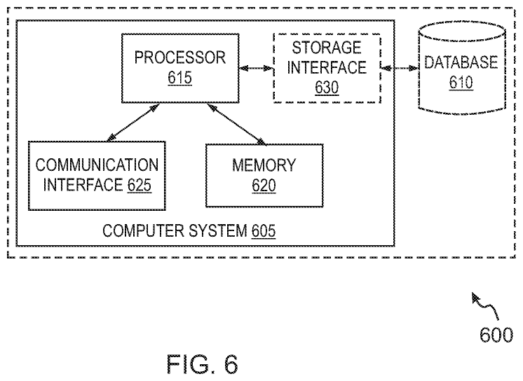

FIG. 6 illustrates a block diagram representation of a server 600 capable of implementing at least one some embodiments of the present disclosure. The server 600 is configured to host and manage the application interface 112 that is provided to an electronic device such as the device 106, in accordance with an example embodiment of the disclosure. An example of the server 600 may be the server 116 or the control unit or the processor shown and already described with reference to FIG. 1. The server 600 includes a computer system 605 and a database 610.

The computer system 605 includes at least one processor 615 for executing instructions. Instructions may be stored in, for example, but not limited to, a memory 620. The processor 615 may include one or more processing units (e.g., in a multi-core configuration).

The memory 620 is a storage device embodied as one or more volatile memory devices, one or more non-volatile memory devices, and/or a combination of one or more volatile memory devices and non-volatile memory devices, for storing micro-contents information and instructions. The memory 620 may be embodied as magnetic storage devices (such as hard disk drives, floppy disks, magnetic tapes, etc.), optical magnetic storage devices (e.g., magneto-optical disks), CD-ROM (compact disc read only memory), CD-R (compact disc recordable), CD-R/W (compact disc rewritable), DVD (Digital Versatile Disc), BD (Blu-ray® Disc), and semiconductor memories (such as mask ROM, PROM (programmable ROM), EPROM (erasable PROM), flash ROM, RAM (random access memory), etc.).

The processor 615 is operatively coupled to a communication interface 625 such that the computer system 605 is capable of communicating with the one or more computing devices, for example, the device 106 or communicates with any entity within the network 110 via the communication interface 625.

The processor 615 may also be operatively coupled to the database 610. The database 610 is any computer-operated hardware suitable for storing and/or retrieving data, such as, but not limited to, the delivery information and the instructions provided by the user 102 at the time making the delivery request, data pertaining to the transportation of the receptacle 108, data pertaining to the receptacle 108 . . . etc. The database 610 may include multiple storage units such as hard disks and/or solid-state disks in a redundant array of inexpensive disks (RAID) configuration. The database 610 may include a storage area network (SAN) and/or a network attached storage (NAS) system.

In some embodiments, the database 610 is integrated within the computer system 605. For example, the computer system 605 may include one or more hard disk drives as the database 610. In other embodiments, the database 610 is external to the computer system 605 and may be accessed by the computer system 605 using a storage interface 630. The storage interface 630 is any component capable of providing the processor 615 with access to the database 610. The storage interface 630 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 815 with access to the database 810.

The processor 615 is communicably coupled with the memory 620 and the communication interface 625. The processor 615 is capable of executing the stored machine executable instructions in the memory 620 or within the processor 615 or any storage location accessible to the processor 615. The processor 615 may be embodied in a number of different ways. In an example embodiment, the processor 615 may be embodied as one or more of various processing devices, such as a coprocessor, a microprocessor, a controller, a digital signal processor (DSP), processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like.

The processor 615 performs various functionalities of the server 800 as described herein.

The disclosed methods with reference to FIGS. 1 to 5, or one or more operations of the flow diagram 500 may be implemented using software including computer-executable instructions stored on one or more computer-readable media (e.g., non-transitory computer-readable media, such as one or more optical media discs, volatile memory components (e.g., DRAM or SRAM), or nonvolatile memory or storage components (e.g., hard drives or solid-state nonvolatile memory components, such as Flash memory components) and executed on a computer (e.g., any suitable computer, such as a laptop computer, net book, Web book, tablet computing device, smart phone, or other mobile computing device). Such software may be executed, for example, on a single local computer or in a network environment (e.g., via the Internet, a wide-area network, a local-area network, a remote web-based server, a client-server network (such as a cloud computing network), or other such network) using one or more network computers. Additionally, any of the intermediate or final data created and used during implementation of the disclosed methods or systems may also be stored on one or more computer-readable media (e.g., non-transitory computer-readable media) and are considered to be within the scope of the disclosed technology. Furthermore, any of the software-based embodiments may be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), mobile communications, or other such communication means.

Various embodiments of the disclosure, as discussed above, may be practiced with steps and/or operations in a different order, and/or with hardware elements in configurations, which are different than those which, are disclosed. Therefore, although the disclosure has been described based upon these exemplary embodiments, it is noted that certain modifications, variations, and alternative constructions may be apparent and well within the spirit and scope of the disclosure.

Although various exemplary embodiments of the disclosure are described herein in a language specific to structural features and/or methodological acts, the subject matter defined in the appended claims is not necessarily limited to the specific features or acts described above. Rather, the specific features and acts described above are disclosed as exemplary forms of implementing the claims.

What is claimed is:

1. A package delivery system, the system comprising:
one or more receptacles, each receptacle of the one or more receptacles configured to store a package and conveyable on a guideway network between a first station and a second station, the guideway network including a first set of guideways for allowing transportation of the one or more receptacles between the first station and the second station, and a second set of guideways for parking the one or more receptacles on either of the first station and the second station; and
a control unit communicably coupled with one or more computing devices for receiving a delivery information pertaining to the package, the control unit configured to operate each receptacle of the one or more receptacles corresponding to the delivery information received from the one or more computing devices for delivering the package.

2. The system as claimed in claim 1, wherein the first station is a receiving location of the package and the second station is a delivery location of the package.

3. The system as claimed in claim 1 further comprising one or more intermediate guideways, configured for interconnecting each of the first set of guideways and the second set of guideways via a switching mechanism.

4. The system as claimed in claim 3, wherein the switching mechanism comprises a flange mounted on each of the first set of guideways and the second set of guideways, and coupled to a switching actuator, the flange being operable between a first position and a second position,
wherein at the first position the flange is configured to allow transportation of each receptacle of the one or more receptacles along a guideway of the first set of guideways, and
wherein at the second position the flange is configured to allow switching a lane of each receptacle of the one or more receptacles from the guideway of the first set of guideways to another guideway in the second set of guideways for parking.

5. The system as claimed in claim 1, wherein the delivery information received by the control unit from the one or more computing devices comprises a delivery location and instructions pertaining to the package to be delivered.

6. The system as claimed in claim 5, wherein the control unit is configured to determine an optimal route in the first set of guideways for each receptacle of the one or more receptacles, based on the delivery information received from the user and location of each receptacle of the one or more receptacles traveling on each of the first set of guideways.

7. The system as claimed in claim 1 further comprising a conveying mechanism configured to each receptacle of the one or more receptacles, the conveying mechanism being engaged to a guideway in the first set of guideways for transportation of the one or more receptacles between the first station and the second station along the guideway.

8. The system as claimed in claim 7, wherein the conveying mechanism comprises at least one wheel engaged to the guideway of the first set of guideways, each of the at least one wheel being coupled to a motor powered by a power source configured on each receptacle of the one or more receptacles for actuation, to enable transportation of the one or more receptacles between the first station and the second station.

9. The system as claimed in claim 7 further comprising a lift mechanism configured to each receptacle of the one or more receptacles and extending from the conveying mechanism, the lift mechanism being configured for suspending each receptacle of the one or more receptacle at a predetermined height above a ground surface.

10. The system as claimed in claim 1 further comprising a closure configured on each receptacle of the one or more receptacles, the closure being operable between an open position and a closed position, wherein the closure is configured with a locking mechanism being communicably coupled with the control unit and operable between an unlocked position and a locked position, the locking mechanism is operable to the unlocked position based on an authentication means input by the user.

11. The system as claimed in claim 1 further comprising a Global Positioning System (GPS) sensor communicably coupled with the control unit for determining location of each receptacle of the one or more receptacles, wherein the control unit determines the speed of each receptacle of the one or more receptacles transporting over the guideway network based on the rate of change in location of each receptacle of the one or more receptacles.

12. The system as claimed in claim 1 further comprising a proximity sensor communicably coupled to the control unit and configured to each receptacle of the one or more receptacles for controlling the movement of the one or more receptacles during transportation.

13. A method for delivering a package via a package delivery system, the method comprising:
receiving, by a control unit, a delivery information pertaining to the package from a user via one or more computing devices, the delivery information comprising a delivery location and instructions pertaining to the package to be delivered;
computing, by the control unit, an optimal route in a first set of guideways of a guideway network for transporting each receptacle of one or more receptacles between a first station and a second station, the optimal route computed based on the delivery information received from the user and a location of each receptacle of the one or more receptacles traveling on each of the first set of guideways; and
transporting, by the control unit, each receptacle of the one or more receptacles via a conveying mechanism from the first station to the second station on the optimal route for delivering the package, wherein the first station is a receiving location of the package and the second station is a delivery location of the package.

14. The method as claimed in claim 13 further comprising, operating, by the control unit, a closure of each receptacle of the one or more receptacles for storing the package therein, upon receiving the delivery information from the user.

15. The method as claimed in claim 13 further comprising conveying, by the control unit, each receptacle of the one or more receptacles to a guideway of a second set of guideways from the optimal route via a switching mechanism, for parking each receptacle of the one or more receptacles in the delivery location.

16. The method as claimed in claim 15 further comprising operating, by a control unit, a flange of the switching mechanism to a second position from a first position via a switching actuator for conveying each receptacle of the one or more receptacles to the guideway of the second set of guideways via an intermediate guideway from the optimal route, upon reaching the second station, wherein the intermediate guideway is configured to interconnect the first set of guideways with the second set of guideways.

17. The method as claimed in claim 13 further comprising operating, by a control unit, a locking mechanism, configured to the closure of each receptacle of the one or more receptacles parked on a guideway of the second set of guideways, to an unlocked position from a locked position for collecting the package by the user, wherein the locking mechanism is operable to the unlocked position based on an authentication means input by the user.

18. The method as claimed in claim 13 further comprising monitoring, by the control unit, speed and location of each receptacle of the one or more receptacles based on the readings received from a Global Positioning System (GPS) sensor mounted on the receptacle and communicably coupled with the control unit.

19. The method as claimed in claim 13 further comprising monitoring, by the control unit, movement of each receptacle of the one or more receptacles during transportation, based on the readings received from a proximity sensor mounted on the receptacle.

20. A package delivery system, the system comprising:
one or more receptacles, each receptacle of the one or more receptacles configured for storing a package and conveyable on a guideway network between a first station and a second station, the guideway network including a first set of guideways for allowing transportation of each receptacle of the one or more receptacles between the first station and the second station, and a second set of guideways for parking each receptacle of the one or more receptacles on either of the first station and the second station;
one or more intermediate guideways, configured on the guideway network for interconnecting each of the first set of guideways and the second set of guideways; and
a switching mechanism for interconnecting the first set of guideways and the second set of guideways, the switching mechanism comprising a flange mounted on each of the first set of guideways and the second set of guideways, and coupled to a switching actuator, the flange being operable between a first position and a second position,
wherein at the first position the flange is configured to allow transportation of each receptacle of the one or more receptacles along a guideway of the first set of guideways and at the second position the flange is configured to allow switching a lane of each receptacle of the one or more receptacles from the guideway of the first set of guideways to another guideway in the second set of guideways for parking,
wherein each receptacle of the one or more receptacles comprises:
a closure being operable between an open position and a closing position, wherein the closure is configured with a locking mechanism being communicably coupled with the control unit and operable between an unlocked position and a locked position, the locking mechanism is operable to the unlocked position based on an authentication means input by a user,
a conveying mechanism being engaged to a guideway of the first set of guideways, the conveying mechanism comprising at least one wheel engaged to the guideway and each wheel of the at least one wheel being coupled to an actuator powered by a power source for enabling transportation of the receptacle between the first station and the second station,
a lift mechanism including a first end mounted to the guideway network and another end coupled to the receptacle, the lift mechanism is configured to suspend the receptacle at a predetermined height above the ground surface,
a Global Positioning System (GPS) sensor communicably coupled with the control unit for determining location of the receptacle, wherein the control unit determines the speed of the receptacle traveling on the guideway network based on the rate of change in location,
a proximity sensor communicably coupled to the control unit for controlling the movement of the receptacle during transportation, and
a control unit communicably coupled with one or more computing devices of a user for receiving a delivery information pertaining to the package, the control unit being configured to operate the receptacle corresponding to the delivery information received from the one or more computing devices for delivering the package, the delivery information received by the control unit from the user via the one or more computing devices comprises a delivery location and instructions pertaining to the package to be delivered, wherein the control unit being communicably coupled with the closure, the locking mechanism, the conveying mechanism, the lift mechanism, the switching mechanism, the GPS sensor and the proximity sensor for controlling operation of the receptacle.
